(19) United States
(12) Patent Application Publication
(10) Pub. No.: US 2016/0143073 A1
(43) Pub. Date: May 19, 2016

(54) MOBILE DEVICE, METHOD AND NON-TRANSITORY COMPUTER READABLE MEDIUM FOR OPERATING MOBILE DEVICE

(71) Applicant: INSTITUTE FOR INFORMATION INDUSTRY, TAIPEI (TW)

(72) Inventors: Eden HSU, TAIPEI CITY (TW); Bi-Wei CHEN, New Taipei City (TW)

(21) Appl. No.: 14/557,466

(22) Filed: Dec. 2, 2014

(30) Foreign Application Priority Data
Nov. 18, 2014 (TW) 103139929

(51) Int. Cl. H04W 76/02; H04W 40/24; H04W 8/00

(52) U.S. Cl. CPC H04W 76/023; H04W 8/005; H04W 40/244; H04W 88/08

(57) ABSTRACT

A method for operating a mobile device includes: receiving a first wireless signal from an external wireless signal transmitter, in which the first wireless signal comprises an identification code, and the identification code corresponds to the external wireless signal transmitter; sending a service request comprising the identification code to the information providing device to request the information providing device to provide a real-time information to the mobile device according to the identification code; acquiring communication information of the at least one target mobile device; and providing a second wireless signal to the at least one target mobile device, in which the second wireless signal comprises at least one of the real-time information and the identification code.

### RELATED APPLICATIONS

This application claims priority to Taiwan Application Serial Number 103139929, filed Nov. 18, 2014, which is herein incorporated by reference.

### BACKGROUND

1. Field of Invention

The present invention relates to a mobile device, an operating method thereof, and a non-transitory computer readable medium. More particularly, the present invention relates to a mobile device capable of receiving a wireless signal from an external wireless signal transmitter, an operating method thereof, and a non-transitory computer readable medium.

2. Description of Related Art

With advances in information technology, mobile devices are widely used in our daily lives.

A typical mobile device may be used to receive a wireless signal from an external wireless signal transmitter, and operate according to specific information in the received wireless signal, such as to display a sale message. There are some common used external wireless signal transmitters such as bluetooth signal transmitter, ibeacon, and Wifi signal transmitter. However, due to the limitation of the service range of the external wireless signal transmitter, it is hard for the wireless signal to be spread to a large field. In such a manner, applications of such a technology are restricted.

### SUMMARY

One aspect of the present disclosure is related to a method for operating a mobile device. In accordance with one embodiment of the present disclosure, the mobile device includes a first wireless communication component, a second wireless communication component, a network component, and a processing component. The method includes: receiving, by utilizing the first wireless communication component, a first wireless signal from an external wireless signal transmitter, in which the first wireless signal includes an identification code, and the identification code corresponds to the external wireless signal transmitter; by utilizing the network component, communicating with an information providing device via a base station, and sending a service request including the identification code to the information providing device to request the information providing device to provide a real-time information to the mobile device according to the identification code, in which the base station provides a lookup table, and the lookup table records at least one target mobile device located within a service range of a communication service provided by the base station; acquiring, through the lookup table, communication information of the at least one target mobile device; and providing, by utilizing the second wireless communication component, a second wireless signal to the at least one target mobile device, in which the second wireless signal includes at least one of the real-time information and the identification code.

In accordance with one embodiment of the present disclosure, information in the lookup table is established by information transmitted to the base station from applications respectively installed in the mobile device and the target mobile device, and the information in the lookup table includes the communication information corresponding to the mobile device and the target mobile device.

In accordance with one embodiment of the present disclosure, the lookup table arranges the information in the lookup table corresponding to the mobile device and the target mobile device according to a service code corresponding to applications respectively installed in the mobile device and the target mobile device, and the base station provides the communication service to the mobile device and the target mobile device.

In accordance with one embodiment of the present disclosure, the communication service includes a long-term evolution (LTE) communication service.

In accordance with one embodiment of the present disclosure, the external wireless signal transmitter is a fixed ibeacon, and the first wireless signal is an ibeacon signal.

In accordance with one embodiment of the present disclosure, the second wireless signal is provided to the at least one target mobile device through an LTE-A device-to-device (D2D) communication protocol.

Another aspect of the present disclosure is related to a mobile device. In accordance with one embodiment of the present disclosure, the mobile device includes a first wireless communication component, a second wireless communication component, a network component, and a processing component. The processing component is configured for: receiving, by utilizing the first wireless communication component, a first wireless signal from an external wireless signal transmitter, in which the first wireless signal includes an identification code, and the identification code corresponds to the external wireless signal transmitter; by utilizing the network component, communicating with an information providing device via a base station, and sending a service request including the identification code to the information providing device to request the information providing device to provide a real-time information to the mobile device according to the identification code, in which the base station provides a lookup table, and the lookup table records at least one target mobile device located within a service range of a communication service provided by the base station; acquiring, through the lookup table, communication information of the at least one target mobile device; and providing, by utilizing the second wireless communication component, a second wireless signal to the at least one target mobile device, in which the second wireless signal includes at least one of the real-time information and the identification code.

In accordance with one embodiment of the present disclosure, information in the lookup table is established by information transmitted to the base station from applications respectively installed in the mobile device and the target mobile device, and the information in the lookup table includes the communication information corresponding to the mobile device and the target mobile device.

In accordance with one embodiment of the present disclosure, the lookup table arranges the information in the lookup table corresponding to the mobile device and the target mobile device according to a service code corresponding to applications respectively installed in the mobile device and the target mobile device, and the base station provides the communication service to the mobile device and the target mobile device.

In accordance with one embodiment of the present disclosure, the communication service includes an LTE communication service.

In accordance with one embodiment of the present disclosure, the external wireless signal transmitter is a fixed ibeacon, and the first wireless signal is an ibeacon signal.

In accordance with one embodiment of the present disclosure, the second wireless signal is provided to the at least one target mobile device through an LTE-A D2D communication protocol.

Another aspect of the present disclosure is related to a non-transitory computer readable medium for storing a computer program configured to execute a method for operating a mobile device. In accordance with one embodiment of the present disclosure, the mobile device includes a first wireless communication component, a second wireless communication component, a network component, and a processing component. The method includes: receiving, by utilizing the first wireless communication component, a first wireless signal from an external wireless signal transmitter, in which the first wireless signal includes an identification code, and the identification code corresponds to the external wireless signal transmitter; by utilizing the network component, communicating with an information providing device via a base station, and sending a service request including the identification code to the information providing device to request the information providing device to provide a real-time information to the mobile device according to the identification code, in which the base station provides a lookup table, and the lookup table records at least one target mobile device located within a service range of a communication service provided by the base station; acquiring, through the lookup table, communication information of the at least one target mobile device; and providing, by utilizing the second wireless communication component, a second wireless signal to the at least one target mobile device, in which the second wireless signal includes at least one of the real-time information and the identification code.

In accordance with one embodiment of the present disclosure, information in the lookup table is established by information transmitted to the base station from applications respectively installed in the mobile device and the target mobile device, and the information in the lookup table includes the communication information corresponding to the mobile device and the target mobile device.

In accordance with one embodiment of the present disclosure, the lookup table arranges the information in the lookup table corresponding to the mobile device and the target mobile device according to a service code corresponding to applications respectively installed in the mobile device and the target mobile device, and the base station provides the communication service to the mobile device and the target mobile device.

In accordance with one embodiment of the present disclosure, the communication service includes an LTE communication service.

In accordance with one embodiment of the present disclosure, the external wireless signal transmitter is a fixed ibeacon, and the first wireless signal is an ibeacon signal.

In accordance with one embodiment of the present disclosure, the second wireless signal is provided to the at least one target mobile device through an LTE-A D2D communication protocol.

Through utilizing one embodiment described above, the real-time information or the identification code can be spread to mobile devices located outer the service range of the external wireless signal transmitter effectively.

### BRIEF DESCRIPTION OF THE DRAWINGS

FIG. 1 is a schematic diagram of a mobile device according to one embodiment of the present invention.

FIG. 2 is a schematic diagram of an environment of a mobile device according to one application of the present invention.

FIG. 3 is a flowchart of a method for operating a mobile device according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. §112(f). In particular, the use of “step of” in the claims herein is not intended to invoke the provisions of 35 U.S.C. §112(f).

One aspect of the present disclosure is related to a mobile device. The mobile device can be used to receive a specific wireless signal from a specific wireless signal transmitter, and communicate with other mobile devices through a specific mobile communication technology. To facilitate the description to follow, ibeacon signal and long term evolution (LTE) technology will be taken as examples in the following paragraphs. However, in a different embodiment, another wireless signal (e.g., bluetooth signal) and mobile communication technology are applicable. Thus, the present disclosure is not limited to this embodiment.

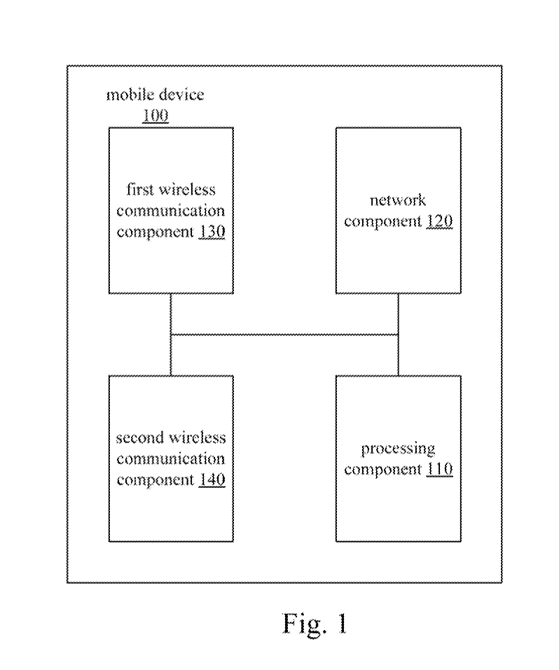

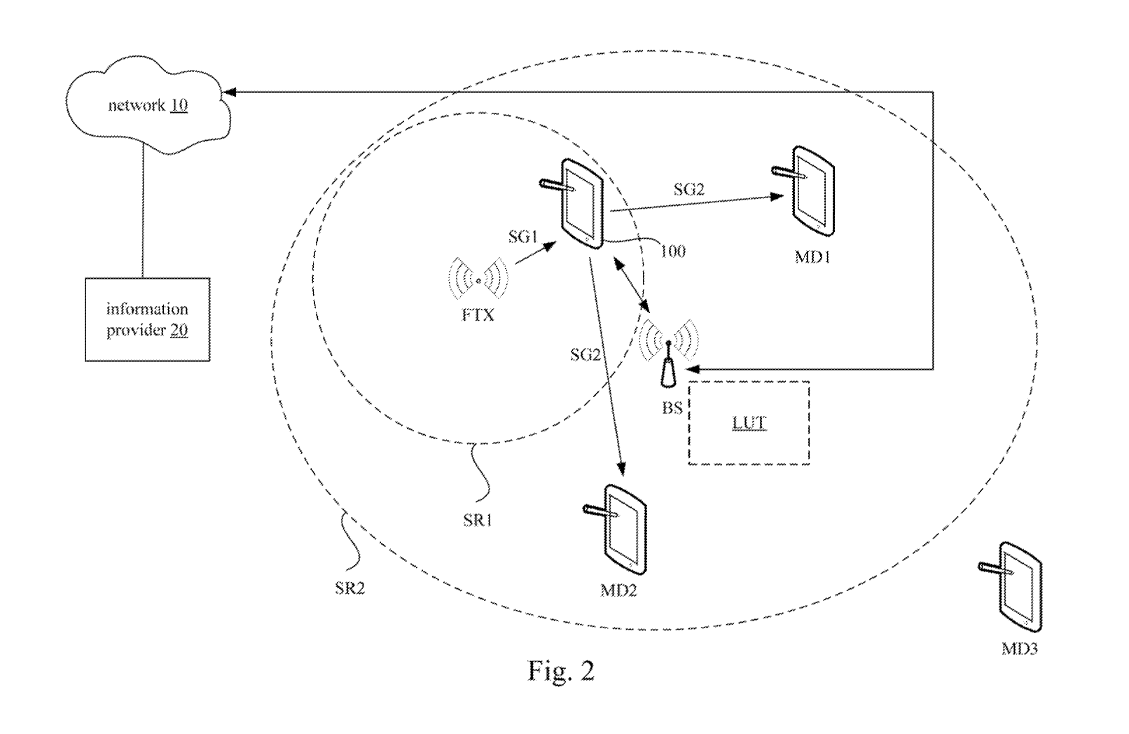

Reference is made to FIGS. 1 and 2. FIG. 1 is a schematic diagram of a mobile device 100 according to one embodiment of the present invention. FIG. 2 is a schematic diagram of an environment of the mobile device 100 according to one application of the present invention.

In this embodiment, the mobile device 100 includes a processing component 110, a network component 120, a first wireless communication component 130, and a second wireless communication component 140. In this embodiment, the processing component 110 may be realized by, for example, a central processing unit (CPU), a microprocessor, or another suitable calculating device. The network component 120 may be realized by, for example, a wireless signal IC. The first wireless communication component 130 may be realized by, for example, an ibeacon, but is not limited in this regard. Another bluetooth signal transceiver or another wireless signal transceiver is applicable. The second wireless communication component 140 may be realized by, for example, an LTE transceiver IC, but is not limited in this regard. Another mobile communication signal transceiver is applicable.

In this embodiment, the first wireless communication component 130 is configured to receive a first wireless signal (e.g., an ibeacon signal) SG1 from an external wireless signal transmitter FTX. The second wireless communication component 140 is configured to communicate with a base station BS and other mobile devices (e.g., target mobile devices MD1, MD2). The network component 120 is configured to connect to the network 10 through the base station BS to request specific data from an information providing device 20. The processing component 110 is configured to process the first wireless signal SG1 received by the first wireless communication component 130, and transmit information corresponding to the first wireless signal SG1 to the target mobile devices MD1, MD2 located outer a service range SR1 of the external wireless signal transmitter FTX.

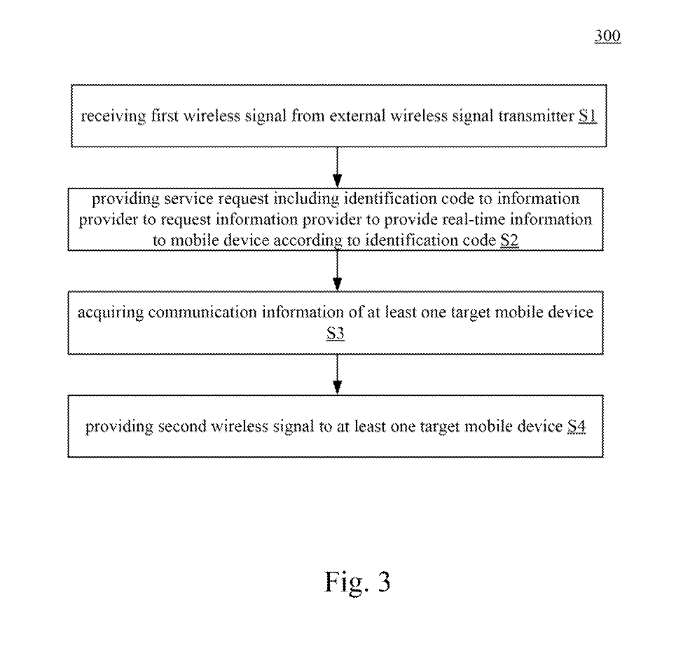

In the following paragraphs, details of the present disclosure are provided with reference to a method for operating a mobile device shown in FIG. 3. However, the present disclosure is not limited to the embodiment below.

FIG. 3 is a flowchart of a method 300 for operating a mobile device according to one embodiment of the present invention. The method 300 can be applied to a mobile device having a structure that is the same as or similar to the structure shown in FIG. 1. To simplify the description below, in the following paragraphs, the embodiment shown in FIG. 1 will be used as an example to describe the method 300 according to an embodiment of the present disclosure. However, the present disclosure is not limited to application to the embodiment shown in FIG. 1.

It should be noted that, the method 300 can be implemented by using the mobile device 100 in the embodiment described above, or can be implemented as a computer program stored in a non-transitory computer readable medium to be read for controlling a computer or an electronic device to execute the method 300. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

In addition, it should be noted that, in the steps of the following method 300, no particular sequence is required unless otherwise specified. Moreover, the following steps also may be performed simultaneously or the execution times thereof may at least partially overlap.

Furthermore, the steps of the following method 300 may be added, replaced, and/or eliminated as appropriate, in accordance with various embodiments of the present disclosure.

In this embodiment, the method 300 includes the steps below.

In step S1, the processing component 110 utilizes the first wireless communication component 130 to receive a first wireless signal SG1 from the external wireless signal transmitter FTX. In one embodiment, the external wireless signal transmitter FTX is a fix ibeacon, and the first wireless signal SG1 is an ibeacon signal.

For example, the external wireless signal transmitter FTX may be fixedly disposed in a department store. When the mobile device 100 enters the service range SR1 of the external wireless signal transmitter FTX, the mobile device 100 can receive the first wireless signal SG1 from the external wireless signal transmitter FTX.

In this embodiment, the first wireless signal SG1 may include an identification code. The identification code corresponds to the external wireless signal transmitter FTX. That is, based on the identification code, the external wireless signal transmitter FTX corresponding to the first wireless signal SG1 can be identified.

In addition, in one embodiment, the first wireless signal SG1 may be an ibeacon signal but is not limited in this regard. Another wireless signal (e.g., a bluetooth signal or a Wifi signal) is applicable.

In step S2, after the first wireless signal SG1 is received, the processing component 110 utilizes the network component 120 to connect to the network 10 and communicate with the information providing device 20 through the base station BS. In addition, the processing component 110 utilizes the network component 120 to send a service request including the identification code to the information providing device 20, to request the information providing device 20 to provide a real-time information to the mobile device 100 according to the identification code in this service request.

In one embodiment, the processing component 110 may utilize the second wireless communication component 140 to communicate with the base station BS. The base station BS may be an LTE mobile base station, configured to provide LTE communication services to mobile devices located within the service range SR2 of the base station BS (e.g., mobile device 100 and target mobile devices MD1, MD2). However, the embodiment is not limited to such an embodiment. Another base station and communication service are within the contemplated scope of the present disclosure.

In this embodiment, the base station BS may provide a lookup table LUT. The lookup table LUT can be used to record information of mobile devices having specific applications respectively installed therein and located within the service range SR2 of the base station BS (e.g., mobile device 100 and target mobile devices MD1, MD2).

For example, when a mobile device having a specific application installed therein enters the service range SR2 of the base station BS, this mobile device will provide information corresponding thereto (e.g., a media access control (MAC) address thereof) to the base station BS, so as to allow the lookup table LUT to record the information.

In one embodiment, said mobile device having the specific application installed therein can further provide a service code corresponding to this specific application to the base station BS, so as to allow the lookup table LUT to accordingly set and arrange the information therein corresponding to the mobile device 100 and the target mobile devices MD1, MD2. That is, according to the service codes provided by the mobile devices which have the specific applications respectively installed therein and are located within the service range SR2 of the communication service provided by the base station BS (e.g., the mobile device 100 and the target mobile devices MD1, MD2), the lookup table LUT sets and arranges the information recorded therein corresponding to the mobile device 100 and the target mobile devices MD1, MD2.

For example, in the lookup table LUT, information of mobile devices corresponding to identical service code may be clustered into a same group.

In one embodiment, the processing component 110 may utilize an application installed therein to send the aforementioned service request which includes the identification code to the information providing device 20.

In one embodiment, the real-time information can be, for example, a sale message of a department store. That is, when the mobile device 100 enters the service range SR1 of the external wireless signal transmitter FTX, the mobile device 100 can obtain the sale message of the department store through the network 10.

In step S3, the processing component 110 utilizes the second wireless communication component 140 to acquire communication information of other mobile devices located within the service range SR2 of the communication service provided by the base station BS (e.g., the target mobile devices MD1, MD2). In one embodiment, the communication information is MAC addresses.

In step S4, after the communication information of other mobile devices located within the service range SR2 of the communication service provided by the base station BS (e.g., the target mobile devices MD1, MD2) is acquired, the processing component 110 utilizes the second wireless communication component 140 to provide a second wireless signal SG2 to these mobile devices located within the service range SR2 (e.g., the target mobile devices MD1, MD2).

In one embodiment, the second wireless signal SG2 includes at least one of the real-time information and the identification code. After the second wireless signal SG2 including the identification code is transmitted to the target mobile devices MD1, MD2, the target mobile devices MD1, MD2 can utilize an application installed therein to request the real-time information from the information providing device 20 according to the identification code. In such a manner, the real-time information can be spread to mobile devices located outer the service range SR1 of the external wireless signal transmitter FTX effectively.

In addition, in this embodiment, since the mobile device MD3 is located outer the service range SR2 of the communication service provided by the base station BS, the mobile device MD3 does not receive the real-time information or the identification code aforementioned. In such a configuration, it can avoid another mobile device which located far away from the mobile device 100 to receive the real-time information or the identification code.

In one embodiment, the processing component 110 can provide the second wireless signal SG2 to other mobile devices located in the service range SR2 of the communication service provided by the base station BS through an LTE-A device-to-device (D2D) communication protocol. However, the present disclosure is not limited in this regard, another communication technology is within the contemplate scope of the present disclosure.

Although the present invention has been described in considerable detail with reference to certain embodiments thereof, other embodiments are possible. Therefore, the scope of the appended claims should not be limited to the description of the embodiments contained herein.

What is claimed is:

1. A method for operating a mobile device, wherein the mobile device comprises a first wireless communication component, a second wireless communication component, a network component, and a processing component, the method comprising:
receiving, by utilizing the first wireless communication component, a first wireless signal from an external wireless signal transmitter, wherein the first wireless signal comprises an identification code, and the identification code corresponds to the external wireless signal transmitter;
by utilizing the network component, communicating with an information providing device via a base station, and sending a service request comprising the identification code to the information providing device to request the information providing device to provide a real-time information to the mobile device according to the identification code, wherein the base station provides a lookup table, and the lookup table records at least one target mobile device located within a service range of a communication service provided by the base station;
acquiring, through the lookup table, communication information of the at least one target mobile device; and
providing, by utilizing the second wireless communication component, a second wireless signal to the at least one target mobile device, wherein the second wireless signal comprises at least one of the real-time information and the identification code.

2. The method as claimed in claim 1, wherein information in the lookup table is established by information transmitted to the base station from applications respectively installed in the mobile device and the target mobile device, and the information in the lookup table comprises the communication information corresponding to the mobile device and the target mobile device.

3. The method as claimed in claim 1, wherein the lookup table arranges the information in the lookup table corresponding to the mobile device and the target mobile device according to a service code corresponding to applications respectively installed in the mobile device and the target mobile device, and the base station provides the communication service to the mobile device and the target mobile device.

4. The method as claimed in claim 1, wherein the communication service comprises a long-term evolution (LTE) communication service.

5. The method as claimed in claim 1, wherein the external wireless signal transmitter is a fixed ibeacon, and the first wireless signal is an ibeacon signal.

6. The method as claimed in claim 1, wherein the second wireless signal is provided to the at least one target mobile device through an LTE-A device-to-device (D2D) communication protocol.

7. A mobile device comprising:
a first wireless communication component;
a second wireless communication component;
a network component; and
a processing component configured for:
receiving, by utilizing the first wireless communication component, a first wireless signal from an external wireless signal transmitter, wherein the first wireless signal comprises an identification code, and the identification code corresponds to the external wireless signal transmitter;
by utilizing the network component, communicating with an information providing device via a base station, and sending a service request comprising the identification code to the information providing device to request the information providing device to provide a real-time information to the mobile device according to the identification code, wherein the base station provides a lookup table, and the lookup table records at least one target mobile device located within a service range of a communication service provided by the base station;
acquiring, through the lookup table, communication information of the at least one target mobile device; and
providing, by utilizing the second wireless communication component, a second wireless signal to the at least one target mobile device, wherein the second wireless signal comprises at least one of the real-time information and the identification code.

8. The mobile device as claimed in claim 7, wherein information in the lookup table is established by information transmitted to the base station from applications respectively installed in the mobile device and the target mobile device, and the information in the lookup table comprises the communication information corresponding to the mobile device and the target mobile device.

9. The mobile device as claimed in claim 7, wherein the lookup table arranges the information in the lookup table corresponding to the mobile device and the target mobile device according to a service code corresponding to applications respectively installed in the mobile device and the target mobile device, and the base station provides the communication service to the mobile device and the target mobile device.

10. The mobile device as claimed in claim 7, wherein the communication service comprises an LTE communication service.

11. The mobile device as claimed in claim 7, wherein the external wireless signal transmitter is a fixed ibeacon, and the first wireless signal is an ibeacon signal.

12. The mobile device as claimed in claim 7, wherein the second wireless signal is provided to the at least one target mobile device through an LTE-A D2D communication protocol.

13. A non-transitory computer readable medium for storing a computer program configured to execute a method for operating a mobile device, wherein the mobile device comprises a first wireless communication component, a second wireless communication component, a network component, and a processing component, the method comprising:
receiving, by utilizing the first wireless communication component, a first wireless signal from an external wireless signal transmitter, wherein the first wireless signal comprises an identification code, and the identification code corresponds to the external wireless signal transmitter;
by utilizing the network component, communicating with an information providing device via a base station, and sending a service request comprising the identification code to the information providing device to request the information providing device to provide a real-time information to the mobile device according to the identification code, wherein the base station provides a lookup table, and the lookup table records at least one target mobile device located within a service range of a communication service provided by the base station;
acquiring, through the lookup table, communication information of the at least one target mobile device; and
providing, by utilizing the second wireless communication component, a second wireless signal to the at least one target mobile device, wherein the second wireless signal comprises at least one of the real-time information and the identification code.

14. The non-transitory computer readable medium as claimed in claim 13, wherein information in the lookup table is established by information transmitted to the base station from applications respectively installed in the mobile device and the target mobile device, and the information in the lookup table comprises the communication information corresponding to the mobile device and the target mobile device.

15. The non-transitory computer readable medium as claimed in claim 13, wherein the lookup table arranges the information in the lookup table corresponding to the mobile device and the target mobile device according to a service code corresponding to applications respectively installed in the mobile device and the target mobile device, and the base station provides the communication service to the mobile device and the target mobile device.

16. The non-transitory computer readable medium as claimed in claim 13, wherein the communication service comprises an LTE communication service.

17. The non-transitory computer readable medium as claimed in claim 13, wherein the external wireless signal transmitter is a fixed ibeacon, and the first wireless signal is an ibeacon signal.

18. The non-transitory computer readable medium as claimed in claim 13, wherein the second wireless signal is provided to the at least one target mobile device through an LTE-A D2D communication protocol.
